(19) United States
(12) Patent Application Publication
(10) Pub. No.: US 2022/0166207 A1
(43) Pub. Date: May 26, 2022

(54) SYSTEM FOR RELIABLY SEPARATING A LOAD FROM AN ELECTRIC GRID FEEDING THE LOAD

(71) Applicants: Siemens Energy Global GmbH & Co. KG, Munich, Bayern (DE); Siemens Energy AS, Oslo (NO)

(72) Inventors: Veiko Schulz, Buchholz I.D.N (DE); Wolfgang Voss, Oberreichenbach (DE)

(73) Assignees: Siemens Energy Global GmbH & Co. KG, Munich, Bayern (DE); Siemens Energy AS, Oslo (NO)

(21) Appl. No.: 17/612,251

(22) PCT Filed: May 13, 2020
(86) PCT No.: PCT/EP2020/063248

§ 371 Date: Nov. 18, 2021

(30) Foreign Application Priority Data
May 23, 2019 (DE) 10 2019 207 537.1

(51) Int. Cl. H02H 3/10; H02J 3/14; H02H 1/00

(52) U.S. Cl. CPC H02H 3/10; H02H 1/0007; H02J 3/14

(57) ABSTRACT

A system having at least two loads which are connected to a common feed line and can be switched off selectively and at least one interrupter switching element with an externally activatable ignition device is used for safely separating a load from an electric grid feeding the load.

### CROSS REFERENCE TO RELATED APPLICATIONS

This application is the US National Stage of International Application No. PCT/EP2020/063248 filed 13 May 2020, and claims the benefit thereof. The International Application claims the benefit of German Application No. DE 10 2019 207 537.1 filed 23 May 2019. All of the applications are incorporated by reference herein in their entirety.

### FIELD OF INVENTION

The invention generally relates to the protection of electrical consumers, in particular in a DC grid, and specifically to a system having at least two consumers which are connected to a common feed line and can be switched off selectively and to the use of at least one interrupter switching element having an externally activatable ignition apparatus for reliably disconnecting a consumer from a feeding electric grid.

### BACKGROUND OF INVENTION

Using converters with a modular structure gives rise to the task of protecting converters that operate in parallel. Depending on the converter topology, the converters may be two-point converters, multi-point converters or MMC converters (modular multilevel converters).

Semiconductor fuses are used today for protection at the low-voltage level. DC semiconductor fuses are not available for medium-voltage applications. Semiconductor fuses are relatively expensive and are not available in the medium-voltage range. Fuses cannot be switched off with a command, with the result that selective active tripping based on a current measurement value and/or a voltage measurement value cannot be implemented. In addition, in the case of fuses, simultaneous tripping of several fuses in the microsecond range cannot reliably be achieved.

Semiconductor fuses must be selected according to the rated current, overload current and short-circuit current, which leads to a higher variance. A sensitive and selective layout requires a higher engineering effort. If the configuration can be changed further after the design, a safe layout cannot be guaranteed.

In critical configurations, it may be necessary to provide additional DC link capacitances in order to ensure selectivity.

### SUMMARY OF INVENTION

It is an object of the present invention to specify an option for protecting parallel converters which avoids the disadvantages outlined above.

This object is achieved according to the invention by means of a system having the features of the independent claim.

The system comprises at least two consumers, in particular converters, which are connected to a common feed line. Each consumer comprised by the system is connected to the common feed line by means of its own parallel branch. Each consumer comprised by the system is assigned in the parallel branch leading to the respective consumer at least one interrupter switching element having an externally activatable ignition apparatus, in particular by virtue of said ignition apparatus being connected in a current path of the parallel branch. By means of the at least one interrupter switching element, each consumer can be selectively switched off individually by activating the or each respective interrupter switching element and is selectively switched off individually during operation by activating the or each respective interrupter switching element.

Each consumer comprised by the system is assigned in the parallel branch leading to the respective consumer at least one current measuring device, for example by virtue of a shunt resistor being connected in a current path of the parallel branch. A current flowing in the parallel branch during operation can be detected by means of the current measuring device and a current flowing in the parallel branch during operation is detected by means of the current measuring device. In an embodiment, the current measuring device is also intended and set up to detect the direction of the current.

Depending on the current (current intensity, in particular current intensity and current direction) flowing in the parallel branch, the ignition apparatus of the at least one interrupter switching element can be activated in the respective parallel branch and the ignition apparatus of the interrupter switching element is activated in the respective parallel branch during operation.

In order to increase reliability, tripping based on a DC voltage measurement and based on a di/dt measurement can also additionally be used. A selection of individual trip criteria or a combination of several trip criteria is optionally possible.

The possibility of actuating the at least one interrupter switching element, for example due to a short circuit occurring in the parallel branch, can be used for active tripping (commanded tripping) of at least one interrupter switching element by way of the detected current measurement value together with the detection of the direction of the current. A possibility for passive tripping, for example in a temperature-dependent manner due to overload, is still available. Tripping of at least one interrupter switching element causes at least one current path to the respective consumer to be disconnected. Active tripping accordingly causes a commanded switch-off of the consumer that contains the short circuit. When a current measurement value is detected in the parallel branch, a commanded switch-off of the respective consumer is possible, for example, in the event of an overcurrent situation. Since such or similar active tripping only takes place when a certain condition is met, selective active tripping is implemented. Consumers feeding short-circuit current into the feed line are identified via the direction of the current and the interrupter elements in this consumer/converter are not tripped.

Interrupter switching elements of the type mentioned above are basically known per se. DE 10 2016 124 176 A1 discloses an electrical interrupter switching element specifically intended for interrupting high currents at high voltages. This is based on an activatable ignition apparatus (mini-detonator) with pyrotechnic material in a housing, which is configured to withstand a pressure that arises during the pyrotechnic tripping. A similar apparatus is known from DE 10 2014 115 397 A1. The content of these documents is hereby fully incorporated into the description presented here, also for the purpose of including features of these documents in claims to define the invention on which the description presented here is based.

Advantageous refinements of the invention are the subject matter of the dependent claims. Back-references used in this context within the claims indicate the further development of the subject of the referenced claim by means of the features of the respective dependent claim. They are not intended to be understood as dispensing with the achievement of independent, substantive protection for the features or combinations of features of a dependent claim. In addition, with regard to interpreting the claims and the description in the case of more specific concretization of a feature in a dependent claim, it should be assumed that such a restriction is not present in the respective preceding claims and a more general embodiment of the substantive method/the substantive apparatus. Any reference in the description to aspects of dependent claims should accordingly be read expressly as a description of optional features, even without a specific indication.

For use as an interrupter switching element at each output in the case of parallel converters on a common feed line, higher di/dt values occur, driven by the DC link capacitances of the converters together with low-inductance connections of 1 μH to 10 μH between the parallel converters. Specific optimizations are advantageously provided for the interrupter switching element. In this respect, for example, the current-carrying pipe is made of a mechanically softer material. For example, aluminum may be considered as a material. Furthermore, for example, the charge of the activatable ignition apparatuses (mini detonator) with pyrotechnic material is increased and the ignition voltage is increased in a range of from 50 V to 80 V (max. possible value of the detonator). As a result, the disconnection process can be started as early as in a time window of 20 οs to 40 μs.

In addition, pyrotechnic material can be introduced within the interrupter switching element, which is used as an additional trip mechanism. If the activatable ignition apparatuses are triggered, the internal pyrotechnic material is ignited immediately afterwards and a second detonation is initiated, which leads to a rapid disconnection and thus a high counter voltage with a rapid reduction in the current as a result.

In one embodiment of the system, each consumer comprised by the system is assigned in the parallel branch leading to the respective consumer the aforementioned current measuring device and additionally a voltage measuring device. For the voltage measurement, for example, a voltage divider connected to ground is connected to a current path of the parallel branch and a potential at the center tap of the voltage divider acts as a measure for the voltage applied to the parallel branch. A voltage present in the parallel branch during operation can be detected and a voltage present in the parallel branch during operation is detected by means of the voltage measuring device. As an alternative, the entire DC link voltage can also be measured. The ignition apparatus of the at least one interrupter switching element in the respective parallel branch can be actuated depending on the current flowing in the parallel branch and depending on the voltage present in the parallel branch and is actuated during operation depending on the current flowing in the parallel branch and depending on the voltage present in the parallel branch. The possibility of taking into account a voltage measurement value resulting from the voltage measurement in addition to a current measurement value resulting from the current measurement adds a further parameter for a selective active tripping of the at least one interrupter switching element. Active tripping can thus take place, for example, in the event of an overcurrent situation or in the event of an undervoltage situation. Since such or similar active tripping only takes place when a certain condition (direction of the short-circuit current) is met, selective active tripping is implemented.

In a further embodiment of the system, at least two interrupter switching elements connected in series and having externally activatable ignition apparatuses in each parallel branch are provided, wherein interrupter switching elements connected in series in one and the same parallel branch can be actuated in parallel and at the same time. A series connection of a plurality of interrupter switching elements, that is to say for example a series connection of two interrupter switching elements, allows higher voltages in the respective parallel branch. The ignition apparatuses (detonators) of the interrupter switching elements which are connected in series can be actuated in parallel and at the same time, and are actuated in parallel and at the same time in the event of an active tripping. Due to the low scatter of the detonators (a few microseconds), a series connection is possible without obtaining major voltage asymmetries across the series connection.

In a particularly advantageous embodiment of the system, each consumer comprised by the system is preceded in the respective parallel branch by a series circuit composed of an actuatable semiconductor switching element, for example a thyristor, and a switching element functioning as a current sink, for example a capacitor. The series circuit composed of the semiconductor switching element and the switching element functioning as a current sink is connected to the two current paths of the parallel branch and is thus connected upstream of the consumer in parallel. The actuatable semiconductor switching element can be actuated depending on the current flowing in the parallel branch and, during operation, is actuated depending on the current flowing in the parallel branch. When the semiconductor switching element is actuated, it becomes conducting and thus the switching element functioning as a current sink is electrically conductively connected to the two current paths of the parallel branch. At least some of the current flowing in the parallel branch thus flows into the switching element functioning as a current sink. Since the semiconductor switching element can be actuated and is actuated depending on the current flowing in the parallel branch, the actuation takes place, for example, in the event of an overcurrent situation, for example in the event of a short circuit. At least some of the current, that is to say for example the short-circuit current, thus flows into the switching element functioning as a current sink. This reduces the current flowing via the at least one interrupter switching element. In the case of parallel actuation of the at least one interrupter switching element (in parallel and at the same time as the actuation of the semiconductor switching element), the at least one interrupter switching element disconnects the consumer affected by the overcurrent situation from the feeding network, wherein the current to be switched off by means of the at least one interrupter switching element is reduced, namely by the current flowing into the current sink.

In a further advantageous embodiment of the system, the or each interrupter switching element is provided with a temperature color lacquer, that is to say with a lacquer which changes its optical properties, that is to say for example changes color, depending on the temperature. By way of such a surface, it is possible to identify for each interrupter switching element quickly and unequivocally whether it has already tripped, because the heat generated when the ignition apparatus of the interrupter switching element is tripped causes at least one optical property of the temperature color lacquer to change.

In a further advantageous embodiment of the system, a trip circuit of the detonator is provided with a measurement device, which makes it possible to check the function of the interrupter switching element by measuring the resistance of the detonator before the start-up of the entire system. In such an embodiment, the system as a whole is released only after it has been identified that all of the interrupter switching elements are functional. During operation, the function can also be implemented by measuring the voltage.

In a further advantageous embodiment of the system, the at least one interrupter switching element is connected in series with a diode. This results in the summation current to be switched off being considerably reduced for the interrupter switching element to be switched off. This results in a considerable reduction in the energy to be converted, which enables a significant extension of the potential field of application, particularly in terms of size (spatial expansion, number of taps, number of connected consumers) of the common feed line and with respect to medium-voltage distribution circuits. This is particularly possible in applications that do not have to take into account the energy being fed back from the consumers. In the case of the higher-output feedback capability, a single chopper can be used per inverter/consumer.

Overall, the innovation proposed here is also the use of at least one interrupter switching element of the type mentioned above for the safe disconnection of a consumer from a feeding electrical grid, wherein the consumer is connected to one of a plurality of parallel branches outgoing from a feed line and wherein the or each interrupter switching element intended to disconnect (switch off) the consumer can be actuated due to an overcurrent situation and/or a short-term undervoltage situation in the respective parallel branch and is actuated during operation.

One exemplary embodiment of the invention is explained in more detail below with reference to a drawing. Entities or elements corresponding to one another are provided with the same reference signs in all of the figures.

The or each embodiment is not to be understood as a limitation of the invention. Rather, additions and modifications are also thoroughly possible within the scope of the present disclosure, particularly those which can be gathered by a person skilled in the art with regard to the achievement of the object for example by combining or modifying individual features or method steps which are described in connection with the general or specific part of the description and which are contained in the claims and/or the drawing, and which, through combinable features, result in a novel subject matter or in novel method steps or sequences of method steps.

### BRIEF DESCRIPTION OF THE DRAWINGS

In the figures:

FIG. 1 shows a system having two consumers which are connected to a common feed line and have interrupter switching elements for the selective switch-off of each consumer by disconnecting it from the feed line,

FIG. 2 to FIG. 4 show further configurations of a system having two consumers which are connected to a common feed line and have interrupter switching elements for the selective shutdown of each consumer,

FIG. 5 shows an actuation device for actuating at least one interrupter switching element for the selective shutdown of a respective consumer,

FIG. 6 shows an activatable current sink upstream of a consumer that can be selectively switched off in order to reduce the current to be switched off, and

FIG. 7 shows an additional diode in series with the interrupter switching element for reducing the energy content to be absorbed.

### DETAILED DESCRIPTION OF INVENTION

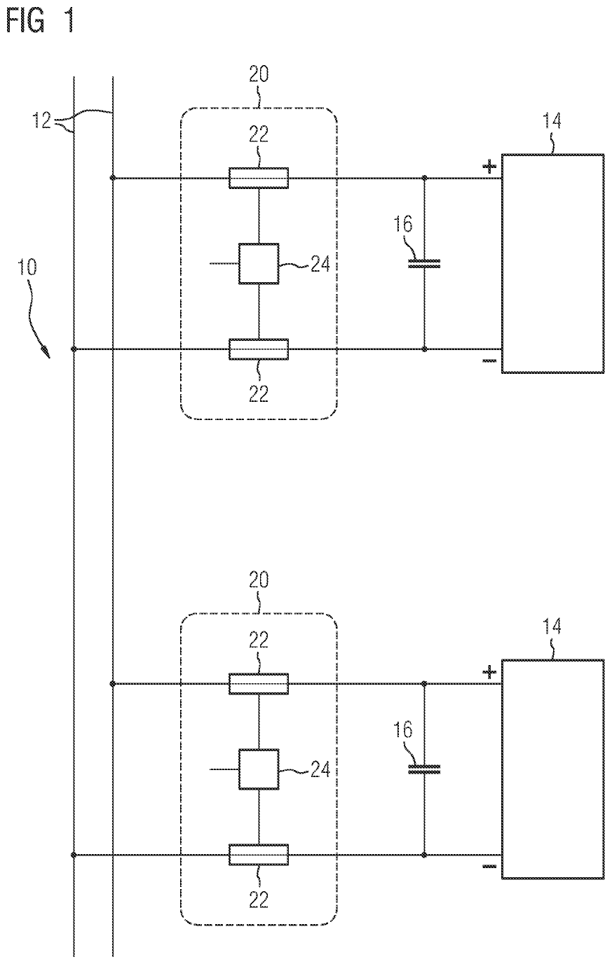

The illustration in FIG. 1 shows an example of a system 10 having at least two consumers 14 which are connected to a common feed line 12 via a respective parallel tap. The feed line 12 is, for example, a DC feed line. A DC feed line having a plurality of parallel taps is often also referred to as a DC bus. In the following text, the feed line 12 is referred to as the DC bus 12 for short, but without renouncing any further general validity. For example, converters (inverters) or a combination of a converter with a drive connected to the converter or another consumer come into consideration as consumers 14. A DC link capacitor 16 is connected upstream of such consumers 14 in a manner basically known per se.

Each consumer 14 comprised by the system 10 is connected to the DC bus 12 by means of its own parallel branch 20. Each consumer 14 comprised by the system 10 is assigned in the parallel branch 20 leading to the respective consumer 14 at least one interrupter switching element 22 having an externally activatable ignition apparatus, at least to protect the consumer 14 and/or to protect the feeding grid. An apparatus considered as an interrupter switching element 22 is known, for example, from DE 10 2014 115 397 A1 or DE 10 2016 124 176 A1.

To activate the at least one interrupter switching element 22, an activation apparatus 24 is provided. This generates, for example, an ignition pulse, which activates the ignition apparatus of the or each interrupter switching element 22 and causes the ignition apparatus to be ignited. Activation of the ignition apparatus of the respective interrupter switching element 22, referred to below for short as actuation of an interrupter switching element 22, causes a reliable and rapid interruption of the electrically conductive connection to the consumer 14 that previously existed via the interrupter switching element 22. After an interrupter switching element 22 has been actuated, for example due to a fault situation (short circuit or the like) in the consumer 14, the respective consumer 14 is reliably disconnected from the DC bus 12.

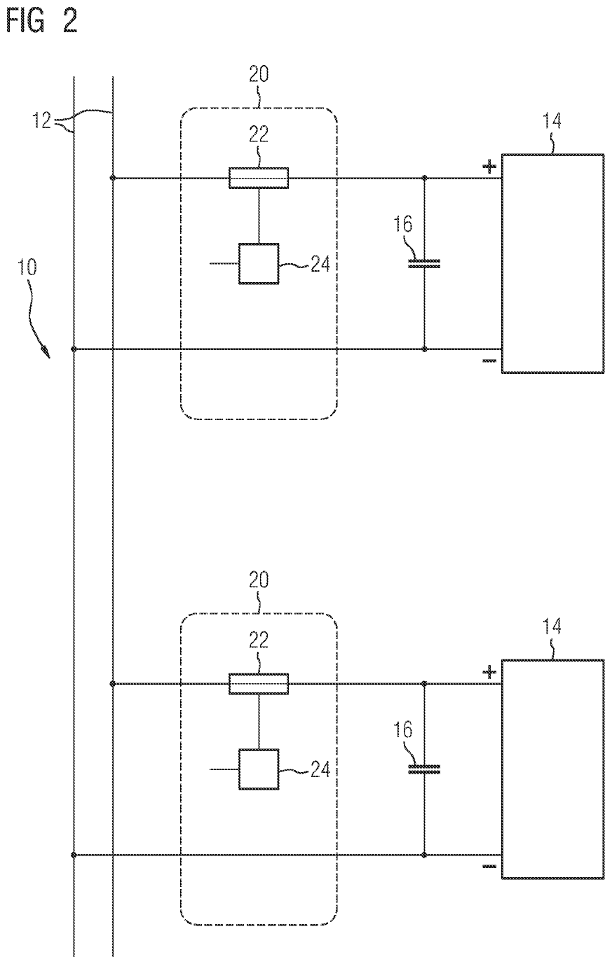

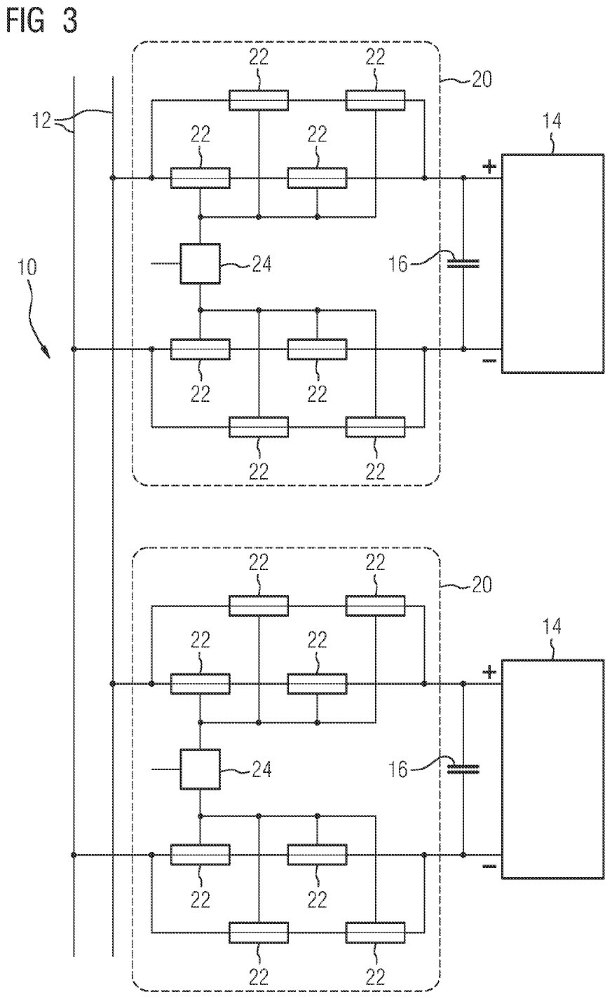

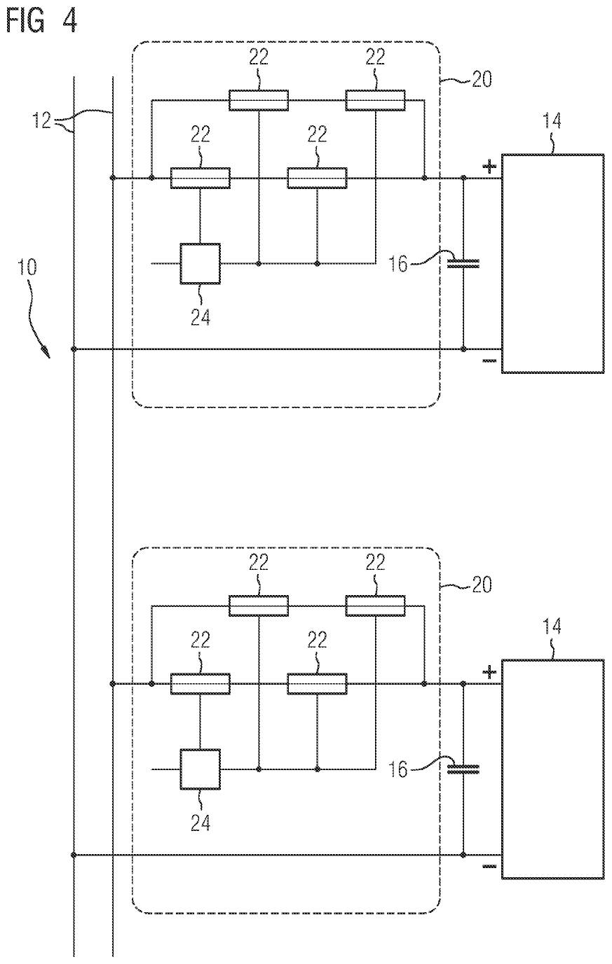

The illustrations in FIG. 2, FIG. 3 and FIG. 4 likewise show a system 10 having at least two consumers 14 connected in parallel with a DC bus 12. The difference from the illustration in FIG. 1 is the position and number of the interrupter switching elements 22.

In the configuration shown in FIG. 1, each consumer 14 is assigned in each of the two current paths (positive branch; negative branch) leading to a respective consumer 14 a respective interrupter switching element 22. In the configuration shown in FIG. 2, each consumer 14 is assigned in only one of the two current paths (positive branch; negative branch) leading to a respective consumer 14 a respective interrupter switching element 22.

In the configuration shown in FIG. 3, each consumer 14 is assigned in each of the two current paths (positive branch; negative branch) leading to a respective consumer 14 at least one series circuit composed of two interrupter switching elements 22, specifically a parallel circuit composed in each case of two interrupter switching elements 22 connected in series.

In the configuration shown in FIG. 4, each consumer 14 is assigned in only one of the two current paths (positive branch; negative branch) leading to a respective consumer 14 at least one series circuit composed of two interrupter switching elements 22, specifically a parallel circuit composed in each case of two interrupter switching elements 22 connected in series.

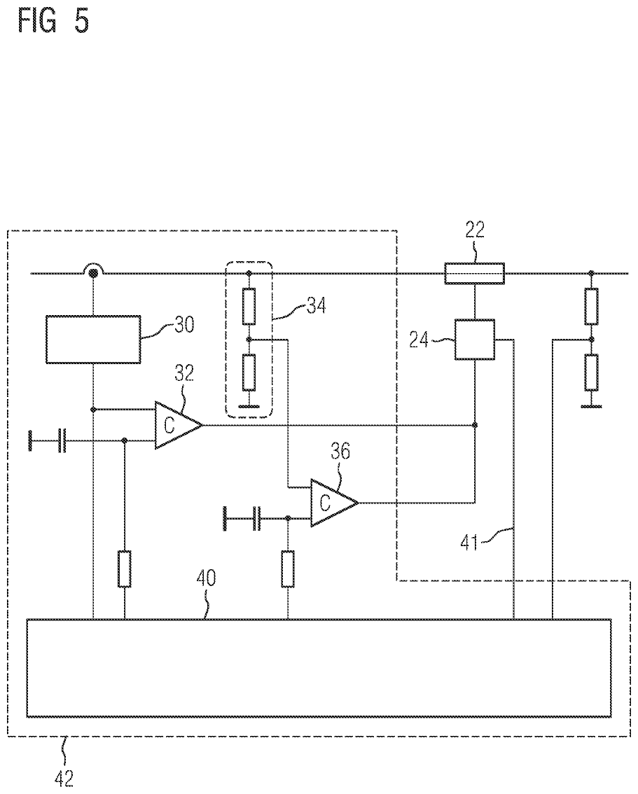

The illustration in FIG. 5 shows an interrupter switching element 22 in a current path leading to a consumer 14 (not shown). The current path starts from the DC bus 12 (likewise not shown). The illustration in FIG. 5 applies to a situation with exactly one interrupter switching element 22 in exactly one current path leading to the respective consumer 14, that is to say for configurations as shown in FIG. 2. The illustration in FIG. 5 applies in the same way to a situation with exactly one interrupter switching element 22 in each current path leading to the respective consumer 14, that is to say for configurations as shown in FIG. 1. The situation shown in FIG. 5 for only one current path then applies to both current paths. The measurement shown in FIG. 5 for only one current path then optionally takes place in both current paths, which leads to higher availability. The illustration in FIG. 5 furthermore also applies to situations with a plurality of interrupter switching elements 22 in each current path leading to the respective consumer 14 or to situations with a plurality of interrupter switching elements 22 in exactly one current path leading to the respective consumer 14, that is to say to configurations as shown in FIG. 3 or FIG. 4. The situation shown in FIG. 5 for only one interrupter switching element 22 then applies to a plurality of interrupter switching elements 22, which are actuated jointly and simultaneously, and possibly for both current paths.

In accordance with FIG. 5, each consumer 14 comprised by the system 10 is assigned in the parallel branch 20 leading to the respective consumer 14 at least one current measuring device 30. A shunt resistor, for example, functions as the current measuring device 30.

A current flowing in the parallel branch 20 during operation can be detected by means of the current measuring device 30 and the current flowing in the parallel branch 20 during operation of the respective consumer 14 is detected by means of the current measuring device 30. The current detection relates at least to a detection of the current intensity and the direction of the current flow. Optionally, the rate of increase in current is also detected as an additional tripping criterion.

A signal that encodes the current intensity that can be detected by means of the current measuring device 30 and that is detected during operation (current measurement value) can be fed to the two inputs of a comparator—first comparator—32 (or another comparison apparatus; referred to in the following text as comparator for short) and is fed to the comparator 32 during operation, in a manner basically known per se, together with a signal encoding a current limit value.

The activation apparatus 24 can be actuated by means of an output signal of the comparator 32 and is actuated during operation by means of the output signal of the comparator 32. The output signal of the comparator 32 can be generated depending on the result of the comparison of the signals present at its two inputs, and is generated during operation depending on the result of the comparison of the signals present at its two inputs. In the event of an overcurrent situation, that is to say a current measurement value exceeding the current limit value, the activation apparatus 24 is actuated and the interrupter switching element 22 (FIG. 2) or a plurality of interrupter switching elements 22 (FIG. 1, FIG. 3, FIG. 4) is or are actuated by means of the actuation of the activation apparatus 24. In the event of an overcurrent situation, the consumer 14 affected by the overcurrent situation is thus reliably disconnected from the DC bus 12.

In the embodiment shown in FIG. 5, a voltage measuring device 34 is provided in addition to the current measuring device, in a basically optional manner. A series circuit composed of two ohmic resistors connected to ground, for example, functions as the voltage measuring device 34. A signal that can be obtained by the voltage measuring device 34, for example the potential present at the center tap of the series circuit, or generally a signal (voltage measurement value) that encodes the electrical voltage in the parallel branch 20 can be fed to the two inputs of a comparator—second comparator—36 (or another comparison apparatus; referred to in the following text as comparator for short) and during operation is fed to the comparator 36, in a manner basically known per se, together with a signal that encodes a voltage limit value.

The activation apparatus 24 can be actuated by means of an output signal of the comparator 36 and is actuated during operation by means of the output signal of the comparator 36. The output signal of the comparator 36 can be generated depending on the result of the comparison of the signals present at its two inputs, and is generated during operation depending on the result of the comparison of the signals present at its two inputs. In the event of an overvoltage situation, that is to say a voltage measurement value exceeding the voltage limit value, the activation apparatus 24 is actuated and the interrupter switching element 22 (FIG. 2) or a plurality of interrupter switching elements 22 (FIG. 1, FIG. 3, FIG. 4) is or are actuated by means of the actuation of the activation apparatus 24. In the event of an undervoltage situation, the consumer 14 affected by the overcurrent situation is reliably disconnected from the DC bus 12.

In the case of a current measuring device 30 connected upstream of the activation apparatus 24 and a voltage measuring device 34 also connected upstream of the activation apparatus 24, the activation apparatus 24 can be activated both by means of the current measuring device 30 and by means of the voltage measuring device 34. The activation apparatus 24 can therefore be activated by means of the current measuring device 30 and by means of the voltage measuring device 34. To activate the activation apparatus 24, however, a corresponding signal from the current measuring device 30 or the voltage measuring device 34 is sufficient. The activation apparatus 24 is accordingly activated when there is an overcurrent situation or a brief undervoltage situation present or when there is an overcurrent situation and an undervoltage situation present.

The current limit value as an input signal for the comparator 32 is generated and provided by means of a logic circuit 40 (for example a logic circuit 40 in the form of a basically known microcontroller, ASIC, FPGA or the like). In the case of a (fundamentally optional, additional) voltage measurement, the voltage limit value is generated and provided as an input signal for the comparator 36 by means of a logic circuit 40, advantageously by means of the same logic circuit 40. The current limit value is specified or can be specified, in particular can be parameterized. In the case of a (fundamentally optional, additional) voltage measurement, the current limit value and the voltage limit value are specified independently of one another or can be specified independently of one another, in particular can be parameterized independently of one another.

The logic circuit 40 also determines the current direction and outputs an enable signal based on the determined current direction via an enable line 41. The enable signal may prevent activation of the activation apparatus 24. An enable signal with a first status blocks the activation apparatus 24 and prevents activation of the activation apparatus 24. An enable signal with a second status, which is complementary to the first status, does not cause the activation apparatus 24 to be blocked, and activation of the activation apparatus 24 is possible.

The activation apparatus 24 is blocked by means of the enable signal if the detected current direction shows that the current flows from the parallel branch 20 in the direction of the DC bus 12. This is the case when there is a short circuit present in a consumer 14 and the short circuit is fed, for example, from the DC link capacitor 16 of at least one further consumer 14 connected to the same DC bus 12. Such a consumer 14 is only indirectly affected by the short circuit and does not need to be switched off. The consumer 14 in which the short circuit is present should, of course, be switched off. The short-circuit current flows into this consumer 14 (current direction from the DC bus 12 in the direction of the consumer 14). In this current direction, the activation apparatus 24 is not blocked. The activation apparatus 24 can be activated on the basis of the current measurement and/or the voltage measurement and, in the event of a short circuit, is activated at least on the basis of the current measurement.

The current measuring device 30, the comparator 32 and the logic circuit 40 that supplies the current limit value together form an actuation device 42, namely an actuation device 42 connected upstream of the activation apparatus 24. Actuation of the activation apparatus 24 is possible by means of an output signal of the actuation device 42, that is to say for example an output signal of the comparator 32, and the activation apparatus 24 is actuated during operation in the event of an overcurrent situation. In the basically optional configuration shown in FIG. 5, the actuation device 42 additionally comprises the voltage measuring device 34 and the comparator 36. Actuation of the activation apparatus 24 is possible by means of an output signal of such an actuation device 42, that is to say for example an output signal of the comparator 32 or an output signal of the comparator 36, and the activation apparatus 24 is actuated during operation in the event of an overcurrent situation or an overvoltage situation.

An actuation device 42 by means of which at least the exceeding of a current limit value can be identified by a current measurement value recorded during operation, that is to say an overcurrent situation can be identified, as well as an actuation device 42 by means of which the activation apparatus 24 can be blocked or enabled depending on the current direction, is shown conceptually in the illustrations in FIG. 1 to FIG. 4 in each parallel branch 20 on the input side of the activation apparatus 24 shown there. The actuation device 42 is optionally a device as shown in FIG. 5, that is to say a device by means of which the exceeding of a current limit value by a current measurement value recorded during operation and the exceeding of a voltage limit value by a voltage measurement value recorded during operation can be identified, that is to say an overcurrent situation and an undervoltage situation can be identified, and such an actuation device 42 is also to be taken into account in the conceptual addition to the illustrations in FIG. 1 to FIG. 4 and represents an advantageous embodiment of the innovation proposed here.

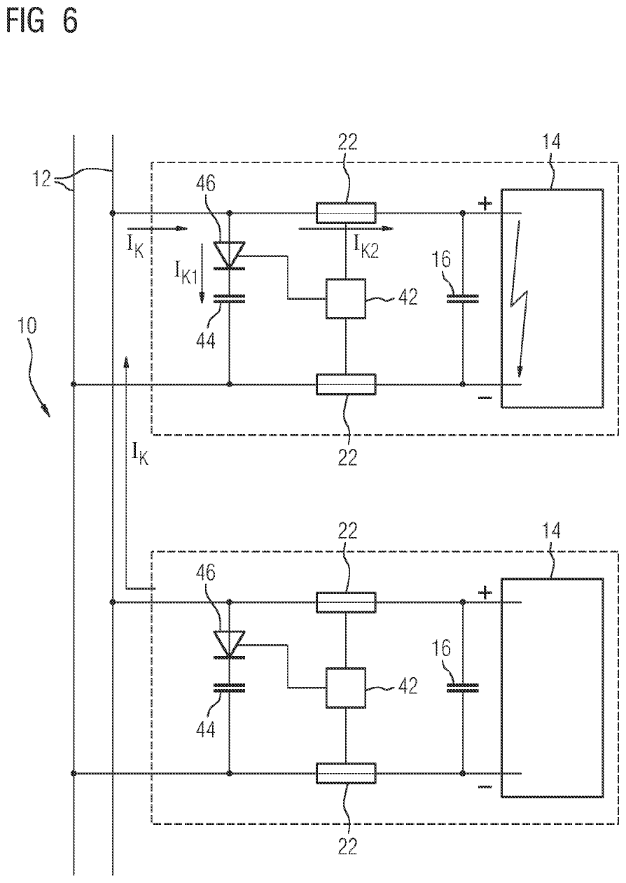

The illustration in FIG. 6 shows a further fundamentally optional embodiment of a circuit in a parallel branch 20 outgoing from the DC bus 12 and leading to a consumer 14. FIG. 6 shows a configuration having in each case one interrupter switching element 22 in each current path of the parallel branch 20 (as in FIG. 1). The special feature of the embodiment shown in FIG. 6 also applies in the same way to the configuration in accordance with FIG. 2 (exactly one interrupter switching element 22 in exactly one current path), the configuration in accordance with FIG. 3 (a plurality of interrupter switching elements 22 in each current path) and the configuration in accordance with FIG. 4 (a plurality of interrupter switching elements 22 in exactly one current path). In the illustration in FIG. 6, the actuation device 42 shown as a block also comprises the activation apparatus 24, which is not illustrated separately for reasons of clarity.

The special feature of the embodiment shown in FIG. 6 consists in a current sink 44 that can be activated on the input side. In the exemplary embodiment shown, a capacitor 44 functions as the current sink 44. The current sink 44 can be activated in that an electronically actuatable semiconductor switching element 46, in the embodiment shown a thyristor 46, is connected upstream of said current sink in a series circuit. The series circuit composed of the semiconductor switching element 46 and the current sink 44 is connected between the two current paths of the parallel branch 20 and thus connected in parallel with the consumer 14 connected to the parallel branch 20.

The semiconductor switching element 46 is actuated by means of the actuation device 42, in particular by means of a signal output by the comparator 32 in the event of an overcurrent situation and thus depending on the current flowing in the parallel branch 20, that is to say for example a short-circuit current I_{K}. The activation of the semiconductor switching element 46 and the activation of an interrupter switching element 22 or a plurality of interrupter switching elements 22 by means of the actuation device 42 take place simultaneously, in particular due to one and the same output signal routed to the semiconductor switching element 46 and to the or each interrupter switching element 22.

The semiconductor switching element 46 becomes conducting due to the actuation and the current sink 44 is thus connected between the two current paths of the parallel branch 20 (the current sink 44 is activated). When the current sink 44 is activated in this way, at least some of the current flowing in the parallel branch 20 flows—in the illustration of FIG. 6 as part I_{K1} of the short-circuit current I_{K} shown—in the current sink 44 (a capacitor 44 acting as a current sink 44 is charged). By rapidly activating the current sink 44, at least some of the current I_{K} flowing in the parallel branch 20, that is to say for example a short-circuit current, is routed into the current sink 44 within the first microseconds after an overcurrent situation has been identified. As a result, the current to be switched off by means of an interrupter switching element 22 or a plurality of interrupter switching elements 22 is reduced. The remaining current to be switched off is shown in the illustration in FIG. 6 as part I_{K2} of the short-circuit current I_{K}; I_{K}=I_{K1} I_{K2}.

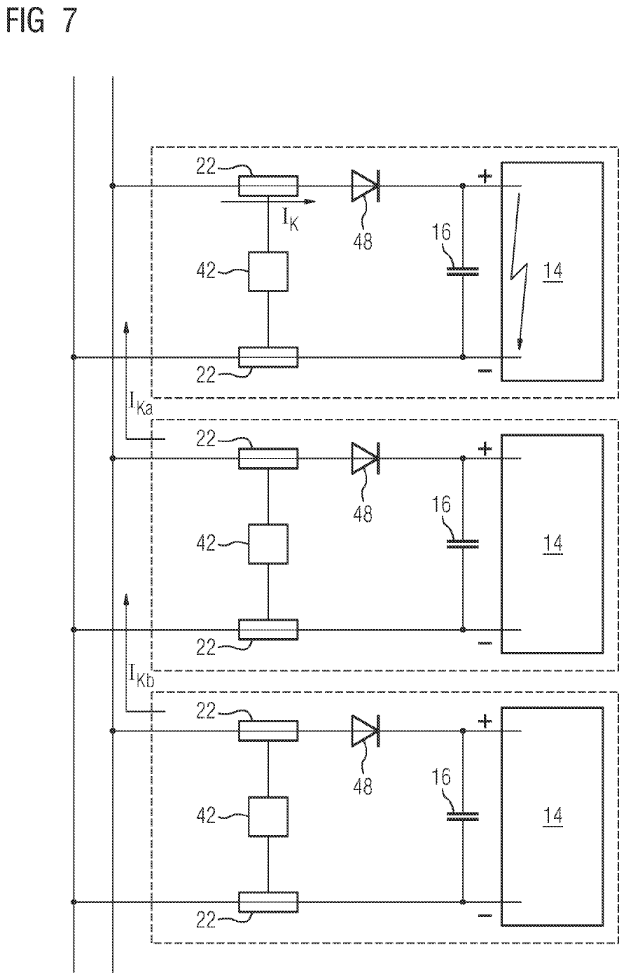

The illustration in FIG. 7 finally shows a further fundamentally optional embodiment of a circuit in a parallel branch 20 outgoing from the DC bus 12 and leading to a consumer 14. FIG. 7 shows—just as in FIG. 6—a configuration having in each case one interrupter switching element 22 in each current path of the parallel branch 20 (as in FIG. 1). The special feature of the embodiment shown in FIG. 7 also applies in the same way to the configuration in accordance with FIG. 2 (exactly one interrupter switching element 22 in exactly one current path), the configuration in accordance with FIG. 3 (a plurality of interrupter switching elements 22 in each current path) and the configuration in accordance with FIG. 4 (a plurality of interrupter switching elements 22 in exactly one current path). In the illustration in FIG. 7, the actuation device 42 shown as a block also—just as in FIG. 6—comprises the activation apparatus 24, which is not illustrated separately for reasons of clarity.

The special feature of the embodiment shown in FIG. 7 consists in at least one diode 48 connected in series with the at least one interrupter switching element 22. The diode 48 is connected in such a way that it is conducting for current flowing from the DC bus 12 into the consumer 14 and blocks a current flow in the opposite direction, that is to say for example a current flow due to the charge of the DC link capacitor 16 in the direction of the DC bus 12. This results in the current to be switched off being reduced for an interrupter switching element 22 to be switched off. This results from the fact that in the event of a short-circuit situation of a consumer 14, for example, no charge can flow away from the DC link capacitors 16 of other consumers 14 and the short-circuit current can increase.

The embodiments in accordance with FIG. 6 and FIG. 7 can optionally be combined and a combination of the embodiments in accordance with FIG. 6 and FIG. 7 is a partial aspect of the innovation proposed here.

Although the invention has been described and illustrated in detail by way of the exemplary embodiment, the invention is not restricted by the disclosed example or examples and other variations can be derived herefrom by a person skilled in the art without departing from the scope of protection of the invention.

Individual aspects of the description submitted here that are in the foreground can thus be briefly summarized as follows: A system 10 having at least two consumers 14 which are connected to a common feed line 12 and can be switched off selectively and the use of at least one interrupter switching element 22 having an externally activatable ignition apparatus for reliably disconnecting a consumer 14 from a feeding electric grid are specified.

1.-7. (canceled)

8. A system, comprising:
at least two consumers which are connected to a common feed line,
wherein each consumer comprised by the system is connected to the common feed line by means of its own parallel branch,
wherein each consumer comprised by the system is assigned in the parallel branch leading to the respective consumer at least one interrupter switching element having an externally activatable ignition apparatus,
wherein each consumer comprised by the system is assigned in the parallel branch leading to the respective consumer at least one current measuring device by means of which a current flowing in the parallel branch during operation is detectable, and
wherein the ignition apparatus of the interrupter switching element in the respective parallel branch is actuated depending on the current flowing in the parallel branch,
wherein the current measuring device is adapted to detect the direction of the current.

9. The system as claimed in claim 8,
wherein each consumer comprised by the system is assigned in the parallel branch leading to the respective consumer the current measuring device and a voltage measuring device,
wherein a voltage present in the parallel branch during operation is detectable by means of the voltage measuring device, and
wherein the ignition apparatus of the interrupter switching element in the respective parallel branch is actuated depending on the current flowing in the parallel branch and depending on the voltage present in the parallel branch.

10. The system as claimed in claim 8, comprising:
at least two interrupter switching elements which are connected in series and have externally activatable ignition apparatuses in each parallel branch,
wherein the interrupter switching elements which are connected in series in one and the same parallel branch are actuated in parallel and at the same time.

11. The system as claimed in claim 8,
wherein each consumer comprised by the system is preceded in the respective parallel branch by a series circuit composed of an actuatable semiconductor switching element and a switching element functioning as a current sink,
wherein the actuatable semiconductor switching element is actuated depending on the current flowing in the parallel branch.

12. The system as claimed in claim 8,
wherein each consumer comprised by the system is preceded in the respective parallel branch by a diode that permits a flow of current in the direction toward the consumer.

13. The system as claimed in claim 8,
wherein each interrupter switching element is provided with a temperature color lacquer.
